(19) United States
(12) Patent Application Publication
(10) Pub. No.: US 2016/0337872 A1
(43) Pub. Date: Nov. 17, 2016

(54) SYSTEM AND METHOD FOR TUNING MIMO ANTENNAS

(71) Applicant: QUALCOMM Incorporated, San Diego, CA (US)

(72) Inventors: Osama Nafeth Saleem Alrabadi, Bad Soden am Taunus (DE); Kevin Boyle, Horsham (GB); Marian Madan, Bad Soden am Taunus (DE)

(21) Appl. No.: 14/710,218

(22) Filed: May 12, 2015

(51) Int. Cl. H04W 24/02; H04W 72/04; H04B 7/04

(52) U.S. Cl. CPC H04W 24/02; H04B 7/0456; H04W 72/0453

(57) ABSTRACT

This disclosure provides a device and method for tuning multiple-in multiple-out (MIMO) antennas. The method can include determining a plurality of subband spectral efficiency values related to the MIMO antennas. The method can also include determining a wideband spectral efficiency by averaging the plurality of subband spectral efficiency values. The method can also include filtering the wideband spectral efficiency using an infinite impulse response (IIR) filter to determine an IIR filtered wideband spectral efficiency. The method can also include determining a cost function based on a maximum value of the IIR filtered wideband spectral efficiency. The method can also include tuning the MIMO antennas based at least in part on the cost function.

### TECHNOLOGICAL FIELD

This disclosure is generally related to wireless communications. More particularly, the disclosure is related to tuning multiple-in multiple-out antennas.

### BACKGROUND

Multiple-in multiple-out (MIMO) antenna tuners aim to maximize power transmitted and power received by the antennas by matching the impedance of the detuned antenna(s). This can be accomplished by minimizing the power reflected from the low noise amplifier (LNA) back to the antenna during reception or from the antenna back to the power amplifier (PA) during transmission. However, other metrics can provide a cost function for optimum reception or transmission from the MIMO antennas.

### SUMMARY

One aspect of the disclosure provides a method for tuning multiple-in multiple-out (MIMO) antennas. The method can include determining a plurality of subband spectral efficiency values related to the MIMO antennas. The method can also include determining a wideband spectral efficiency by averaging the plurality of subband spectral efficiency values. The method can also include filtering the wideband spectral efficiency using an infinite impulse response (IIR) filter to determine an IIR filtered wideband spectral efficiency. The method can also include determining a cost function based on a maximum value of the IIR filtered wideband spectral efficiency. The method can also include tuning the MIMO antennas based at least in part on the cost function.

Another aspect of the disclosure provides a device A device for tuning multiple-in multiple-out (MIMO) antennas. The device can include a processor configured to determine a plurality of subband spectral efficiency values related to the MIMO antennas. The processor can also determine a wideband spectral efficiency by averaging the plurality of subband spectral efficiency values. The processor can also filter the wideband spectral efficiency using an infinite impulse response (IIR) filter to determine an IIR filtered wideband spectral efficiency. The processor can also determine a cost function based on a maximum value of the IIR filtered wideband spectral efficiency. The device can also have a plurality of tuners operably couple to the MIMO antennas, and configured to tune the MIMO antennas based on the cost function.

Another aspect of the disclosure provides an apparatus for tuning antennas in a multiple-in multiple-out (MIMO) system, the MIMO system having a first antenna and a second antenna. The apparatus can have a processor means. The processor means can determine a plurality of subband spectral efficiency values related to the MIMO antennas. The processor means can also determine a wideband spectral efficiency by averaging the plurality of subband spectral efficiency values. The processor means can also filter the maximum wideband spectral efficiency using an infinite impulse response (IIR) filter. The processor means can also determine a cost function based on the maximum IIR filtered wideband spectral efficiency. The apparatus can also have a means for tuning the MIMO antennas based at least in part on the cost function.

Another aspect of the disclosure provides a device for tuning antennas in a multiple-in multiple-out (MIMO) system, the MIMO system having a first antenna and a second antenna. The device can have a processor configured to determine a plurality of subband spectral efficiency values of the MIMO system. The processor can also determine a wideband spectral efficiency based on an average of the plurality of the subband spectral efficiency values. The processor can also filter the wideband spectral efficiency to determine a maximum IIR filtered wideband spectral efficiency. The processor can also determine a cost function based on the maximum IIR filtered wideband spectral efficiency. The device can also have at least one tuner operably coupled to the processor, the first antenna, and the second antenna. The at least one tuner can also tune the first antenna and the second antenna based on the cost function.

Other features and advantages of the present disclosure should be apparent from the following description which illustrates, by way of example, aspects of the disclosure.

### DESCRIPTION OF THE DRAWINGS

The details of the present disclosure, both as to its structure and operation, may be gleaned in part by study of the accompanying drawings, in which like reference numerals refer to like parts, and in which:

FIG. 1 is a graphical representation of a wireless communications system;

FIG. 2 is a functional block diagram of a user equipment in wireless communication with a base station;

FIG. 3 is a functional block diagram showing further functions of the user equipment of FIG. 2;

FIG. 4 is an exemplary plot diagram of spectral efficiency that can be used in a cost function; and

FIG. 5 is a flowchart of a method for tuning MIMO antennas.

### DETAILED DESCRIPTION

The detailed description set forth below, in connection with the accompanying drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in simplified form for brevity of description.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

The disclosure may relate to various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP).

Single carrier frequency division multiple access (SC-FDMA) utilizes single carrier modulation and frequency domain equalization. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently used for uplink multiple access scheme in LTE.

It should be noted that for clarity, the subject matter below is discussed with respect to specific examples of certain signals and message formats used in LTE. However, the applicability of the disclosed methods and systems to other communication systems and other signal transmission/reception technology will be appreciated by one of skill in the art.

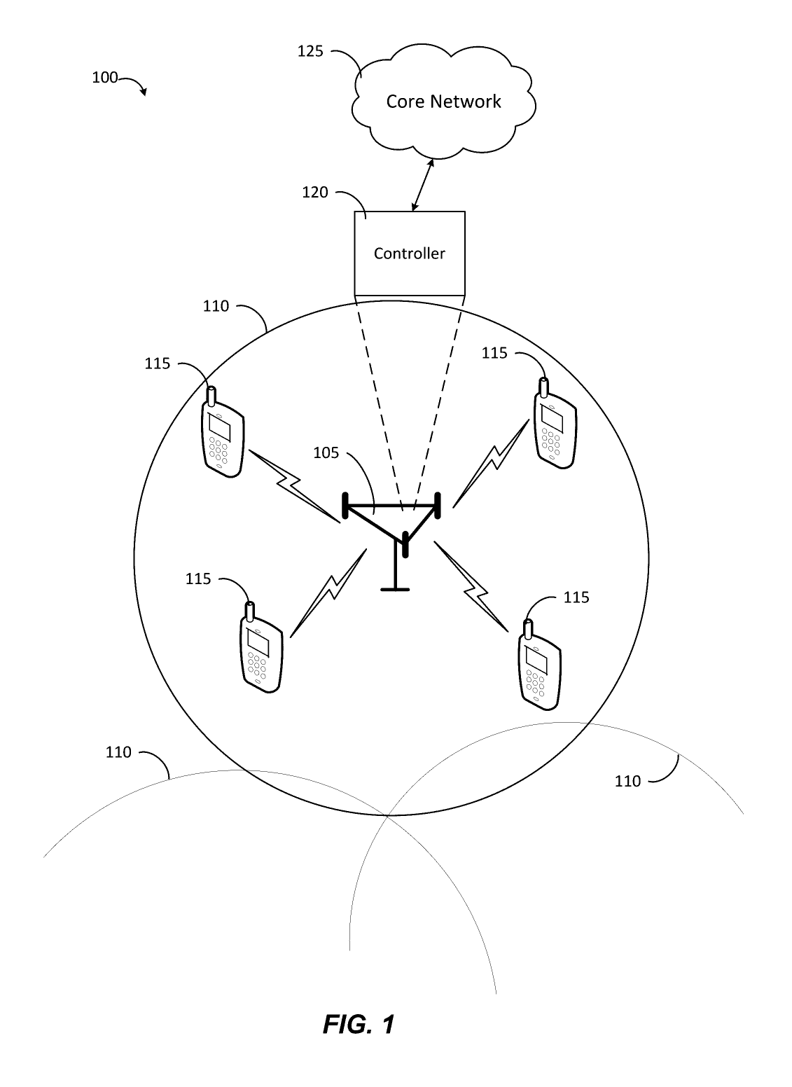

FIG. 1 is a graphical representation of a wireless communications system. A communication system (“system”) 100 can have a base station 105. The base station 105 can wirelessly communicate with a plurality of mobile devices 115. Such communication can occur under the control of a base station controller 120 via multiple carrier signals. Such carrier signals may be referred to herein as “signals” or “carriers.” Each of the base stations 105 can provide communication coverage for a given geographic area. A coverage area 110 for the base station 105 is represented by a large circle encompassing the system 100. While only one system 100 is depicted, multiple systems 100 can be placed adjacent to or overlapping with one another creating a larger network having multiple cells or systems 100, for example, a cellular network. Two other coverage areas 110 are depicted at the bottom of FIG. 1 indicating the possible presence of multiple systems 100 and associated base stations 105 and mobile devices 115. The system 100 can further include multiple base stations 105 of different types (e.g., macro-, micro-, and/or picocell base stations). There may be overlapping coverage areas for different technologies.

The system 100 can further have a base station controller 120, and a core network 125 (the base station controller 120 may be integrated into the core network 125). The system 100 may support operation on multiple carriers (waveform signals of different frequencies).

The mobile devices 115 can be dispersed throughout the coverage areas 110. The mobile devices 115 may be referred to as mobile stations, mobile devices, access terminals (ATs), user equipments (UEs), subscriber stations (SSs), or subscriber units. The mobile devices 115 can include cellular phones and other wireless communications devices, but may also include personal digital assistants (PDAs), other handheld devices, netbooks, notebook computers, etc.

The base station 105 can provide different Radio Access Technologies (RATs). For example, one base station 105 may provide WiMAX-based RATs while another base station 105 may provide CDMA-based RATs. In one configuration, the mobile devices 115 may be multi-mode devices, thereby allowing them to use both WiMAX based RATs and CDMA based RATs, for example.

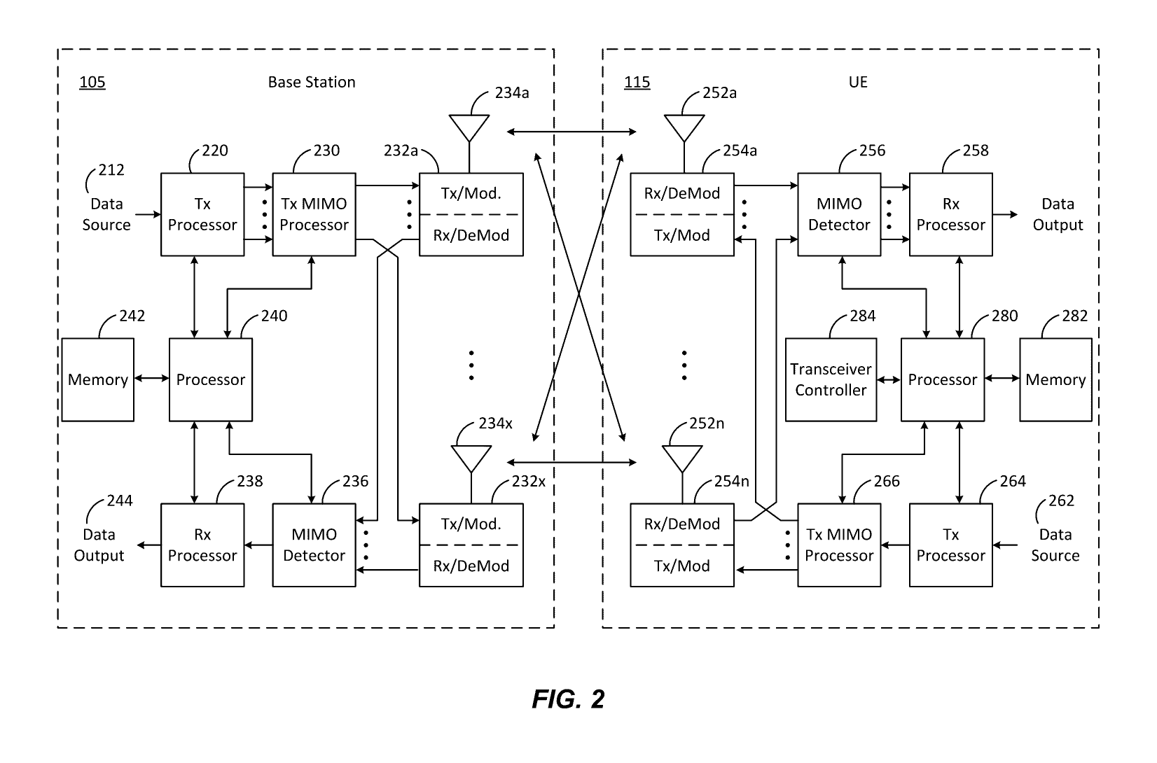

FIG. 2 is a functional block diagram of a user equipment in wireless communication with a base station. A communication system 200 can include the exemplary base station 105 (FIG. 1) and a mobile device 115 (hereinafter UE 115), both indicated in dashed lines. The communication system 200 may be similar to the system 100, or a portion thereof. Additionally, the base station 105 may be, for example, an e-Node B (eNB). The base station 105 can be equipped with X-number of antennas 234a through 234x, while the UE 115 can be equipped with N-number antennas 252a through 252r. In general the values of both X and R are greater than or equal to one, however X and R do not have to be equal. Accordingly, both the base station 105 and the UE 115 can implement certain multiple-in multiple out (MIMO) processes as disclosed herein.

At the base station 105, a transmit processor 220 may receive data from a data source 212. The transmit processor 220 may process the data. The transmit processor 220 may also generate reference symbols, and a cell-specific reference signal. A transmit (TX) MIMO processor 230 may perform spatial processing (e.g., precoding) on data symbols, control symbols, and/or reference symbols, if applicable, and may provide output symbol streams to the transmit modems 232a through 232x (collectively referred to herein as modems 232). While described and labeled individually, in some embodiments, a single modem 232 may modulate and demodulate MIMO transmissions for the base station 105.

The modems 232 may process a respective output symbol stream (e.g., for OFDM, etc.) to obtain an output sample stream. The modems 232 may further process (e.g., convert to analog, amplify, filter, and upconvert) the output sample stream to obtain a downlink (DL) signal. DL signals in this sense may generally be referred to as signals coming from the base station 105 to the UE 115. In at least one example, DL signals from the modems 232a through 232x can be transmitted via the antennas 234a through 234x, respectively.

At the UE 115, the mobile device antennas 252a through 252n may receive the DL signals from the base station 105 and may provide the received signals to the modems 254a through 254n, respectively. The modems 254a-254n may be collectively referred to herein as modems 254. Similar to above, while the modems 254 are described and labeled individually, in some embodiments, a single modem 254 can be implemented.

The modems 254 may condition (e.g., filter, amplify, downconvert, and digitize) a respective received signal to obtain input samples. Each modem 254 may further process the input samples (e.g., for OFDM, etc.) to obtain received symbols. A MIMO detector 256 may obtain received symbols from all the modems 254a through 254n, perform MIMO detection on the received symbols if applicable, and provide detected symbols. A receive processor 258 may process (e.g., demodulate, deinterleave, and decode) the detected symbols, providing decoded data for the UE 115 to a data output, and provide decoded control information to a processor 280, or memory 282.

The UE 115 may include a transceiver controller 284 that can be configured to determine which antennas 252 receive signals from a given base station 110. For example, the transceiver controller 284 may activate a first antenna 252a to receive DL signals from the base station 105, wherein the base station 105 may be currently serving the UE 115. The base station 105 and UE 115 may, therefore, be using the same frequency band and/or the same RAT. While the first antenna 252a is receiving signals from the base station 105, the transceiver controller 284 may also activate at least one other antenna 252n to receive DL signals from another base station 105 servicing a different geographical area than where the UE 115 is currently located. As a result, the other base station 105 and the UE 115 may not be using the same frequency band and/or the same RAT. In various examples, the transceiver controller 284 may activate multiple sets (or groups) of the antennas 252a-252n during the same scan interval so that the antennas 252 receive the signals from different base stations 105 during the same time interval.

On the uplink (UL), at the UE 115, a transmit processor 264 may receive and process data from a data source 262. Uplink, as used herein may generally refer to transmissions coming from the UE 115 to the base station 105. The transmit processor 264 may also generate reference symbols for a reference signal. The symbols from the transmit processor 264 may be precoded by a transmit MIMO processor 266 if applicable, further processed by the modems 254 (e.g., for SC-FDMA, etc.), and be transmitted to the base station 105 in accordance with the transmission parameters received from the base station 105. At the base station 105, the UL signals from the UE 115 may be received by the antennas 234, processed by the modems 232, detected by a MIMO detector 236 if applicable, and further processed by a receive processor 238. The receive processor 238 may provide decoded data to a data output 244 and to the processor 240.

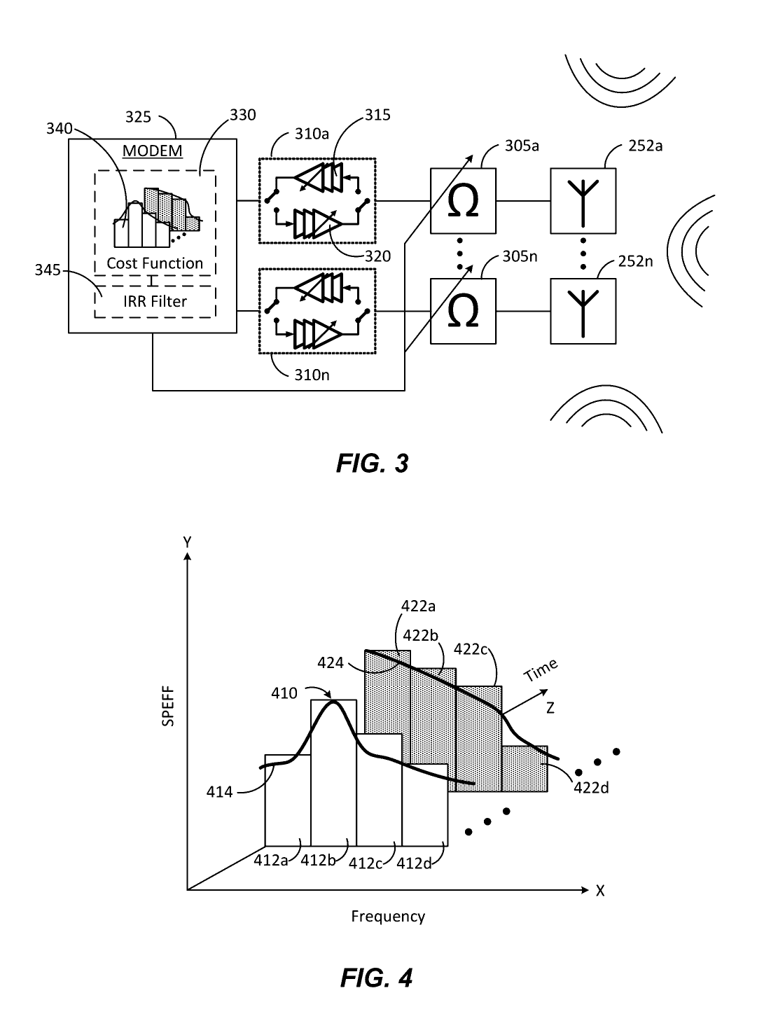

FIG. 3 is a functional block diagram showing further functions of the user equipment of FIG. 2. In some embodiments, the UE 115 can have the antennas 252 as described above. Each of the antennas 252a-252n can be operably coupled to a respective antenna tuner 302a-302n (collectively referred to hereinafter as tuners 305). While the tuners 305 are labeled individually and may be described individually, in some embodiments the tuners 305 may describe the functions of a single tuner 305 operably coupled to all of the antennas 252.

The tuners 305 can further be operably coupled to transceivers 310a-310n. The transceivers 310a-310n may be collectively referred to herein as transceivers 310. The transceivers 310 can each have a low noise amplifier (LNA) 315 and a power amplifier (PA) 320. The UE 115 can switch between transmitting a signal via the PA 320 or receive a signal via the LNA 315, depending on the UL or DL operations.

The tuners 305 can have one or more matching circuits (not shown) configured to match the individual antennas 252 with their respective loads. The frequencies on which UL and DL data is transmitted or received can vary, affecting the resonant frequency and impedance of the antennas 252. The tuners 305 can therefore be configured to match the impedance of the antennas 252 and their associated circuitry to that of the LNA 315 or to the PA 320, depending on particular transmit or receive operations.

The UE 115 can also have at least one modem 325. The modem 325 as described herein can be similar to the modems 254 (FIG. 2). The modem 325 is listed as a single component for simplicity, however the UE 115 can have multiple modems 325 (e.g., the modems 254). The modem 325 may further be configured to perform or share some or all of the functions of the modems 254, the transceiver controller 284, and/or the processor 280. The modem 325 can include one or more processors such as a digital signal processor.

In some embodiments, the modem 325 can be configured to dynamically adjust the tuners 305 to match both tuned and/or detuned antennas 252. The modem 325 can determine certain metrics upon which the antenna performance is measured. The modem 325 can further use such measurements to accurately and efficiently tune the antennas 252.

In some embodiments, the modem 325 can dynamically tune the antennas 252 (e.g., via commands to the tuner 310) in order to most efficiently transmit UL data to the base station 105 and receive DL data from the base station 105. This can result in maximum power transmission and maximum signal reception.

MIMO communications, such as those associated with the system 200 and the UE 115, can use various methods to tune the antennas 252 of the UE 115. The UE 115 and more specifically, the modem 325, can implement a cost function 330 to optimize antenna performance. A “cost function” as used herein may generally refer to one or more metrics or mathematical formulae used to predict the cost/detriment or benefit associated with a certain action or a certain level of output. The cost function 330 is shown as a graph or plot within the modem 325 and represents the one or more mathematical functions used to tune the antennas 252. The plot is described below in connection with FIG. 4.

In some embodiments, the cost function 330 can be configured to operate with various antenna tuning algorithms. As a non-limiting example, such tuning algorithms may include but are not limited the Hamilton Algorithm, the Steepest Gradient Algorithm (SGA), and the Simultaneous Perturbation Stochastic Approximation (SPSA) when the tuner has many tunable components or variables.

The modem 325 can implement the cost function 330 to determine certain adjustments to maximize or optimize power output, power imbalance, and antenna correlation of the antennas 325, among other aspects. Increases in antenna correlation and increases power imbalance affect antenna throughput adversely and independently. The term “antenna correlation” as used herein may generally refer to correlation between a signal's spatial direction and the average received signal gain. Antenna correlation can degrade the performance of multi-antenna MIMO systems (e.g. the system 200 and the UE 115). Antenna correlation can limit the number of antennas 252 that can be effectively implemented in the UE 115 because correlation decreases the number of independent channels that can be created by precoding. Accordingly, a minimum antenna correlation is generally desired in the spatial multiplexing mode of MIMO.

Additionally, it is often desirable to tune the antennas 252 for maximum power output and minimum power imbalance when tuned or detuned. Together, a maximum power output, minimum correlation, and minimum power imbalance, can result in maximum performance of the antennas 252. Accordingly, a compromise between the three aspects is desirable.

One such cost function 330 is aimed at maximizing the power received by the antennas 252 when matching a detuned antenna. This may be accomplished by minimizing power reflected from the LNA 315 back to the antenna 252 during reception or reflected back to the PA 320 during transmission. However, this may not provide an optimum cost function 330 for optimum reception or transmission from all of the antennas 252, because antenna correlation and power imbalance are largely ignored. The impedance matching that optimizes power reception may tend to correlate the antennas 252 or imbalance antenna power.

Overall performance of a MIMO system (e.g., the system 200 of FIG. 2) can be described by spectral efficiency (SPEFF). SPEFF, or bandwidth efficiency, may generally refer to the information rate that can be transmitted over a given bandwidth in a specific communication system (e.g., the system 100, 200). SPEFF is the throughput of the system 200 normalized by the frequency bandwidth over which transmission/reception occurs. SPEFF can depend on power, spatial correlation of the MIMO antennas 252, and power imbalance between the antennas 252.

In some embodiments, the impedance matching that maximizes the SPEFF in a high signal-to-noise (SNR) region is not the same impedance matching that maximizes the received or transmitted power. Rather, the impedance matching that maximizes the SPEFF in the high SNR region is the impedance matching that tends to de-correlate the antennas 252. Maximum SPEFF can occur when there is an optimum compromise among minimum antenna correlation, minimum power imbalance, and maximum power output of the antennas 252.

Therefore the modem 325 can base the cost function 330, at least in part, on a measure of SPEFF 340, as opposed to focusing impedance matching solely on the power reflected from the antennas 252 during transmission or reflected by the LNA 315 during reception.

The SPEFF 340 is depicted as a curve, similar to the plot of FIG. 4 below. The SPEFF 340 can be continuously or periodically calculated at the modem 325. The repeated calculations can then reflect or reveal certain time varying aspects to the MIMO operations of the UE 115. For example, the UE 115 implemented as a mobile telephone may have one or more antennas 252 blocked by a hand or head, in use. The partial or total antenna blockage can then be reflected in varying or degraded values of the SPEFF 340 determinations.

These changes may vary slowly and manifest themselves in antenna performance and SPEFF 340 measurements, caused by for example, a user changing hand grip that affects different antennas 252 during a call. Accordingly, the changes may also fade slowly. Such “slow varying” statistics can reflect mechanical blockage of one or more antennas 252. The slow varying characteristics can further be contrasted with “fast fading” that can otherwise describe certain transmission characteristics of the transmitter, receiver, and the signal.

As the UL or DL transmissions to and from the UE 115 can span large bandwidths, the modem 325 can make SPEFF 340 determinations in smaller, subband portions. As used herein, the term “subband” may generally refer to smaller portions of the bandwidth within the larger, wideband signal or spectrum. The subbands can further correspond to precoding matrix indication (PMI) and rank index (RI) hypotheses exchanged between the UE 115 and the base station 105. Wideband, in contrast, may generally refer to the entire frequency spectrum or spectra in which the UE 115 is operating.

The modem 325 can make SPEFF determinations for each subband and average the subband determinations to determine an average wideband SPEFF (described below in connection with FIG. 4). The modem 325 can then filter the wideband average to achieve a SPEFF 340 that most accurately reflects the slow varying factors negatively affecting the transmission efficiency of the antennas 252.

In some embodiments, the cost function 330 can implement an infinite impulse response (IIR) filter 345. The IIR filter 345 is shown in dashed lines. The IIR filter 345 can produce a weighted sum of current and past inputs. The cost function 330, with properly selected coefficients for the IIR filter 345, can filter the average wideband SPEFF determinations to eliminate effects of fast fading and derive a SPEFF 340 that accurately reflects the slow varying channel statistics. This is generally referred to herein as the IIR filtered wideband SPEFF. The “maximum” IIR filtered wideband SPEFF 340 can then generally reflect the most efficient use of the spectrum. The modem 325 can then use the cost function 330 based on the maximum IIR filtered wideband SPEFF 340 to tune the antennas 252.

FIG. 4 is an exemplary plot diagram of spectral efficiency that can be used in a cost function. A plot diagram (“plot”) 400 is shown with frequency on the X-axis versus SPEFF on the Y-axis. The plot 400 also shows frequency and SPEFF versus time on the Z-axis.

In some embodiments, the modem 325 can make periodic SPEFF calculations in time, as shown. Such calculations can be made for subband portions of the total frequency spectrum in use. The plot 400 shows four subband SPEFF calculations 412a-412d (collectively, subband SPEFF 412). The subband SPEFF 412 is shown as a white bar graph on the plot 400. Each of the four blocks shown is representative of the various SPEFF calculations for each subband made at the modem 325. The subband SPEFF 412 can be the calculations related to subdivided portions of one or more signals, (e.g., an UL or DL signal). The use of only four subband SPEFFs 412 is merely representative of the subband calculations and should therefore not be considered limiting.

The modem 325 can divide the spectrum into subbands based on rank indicator RI and PMI hypotheses, as noted above. RI can specify how many spatial layers the UE 115 is able to decode in single-user (SU) MIMO mode (rank 2, 3, 4). RI can further indicate when the UE 115 can switch between SU-MIMO (rank 2 or greater) and transmit diversity and single-in single-out (SISO) (rank 1). PMI indicates the best-matched precoding matrix to be used by the base station 105 (e.g., an eNB) from a predefined codebook for a current transmission in the case of SU MIMO or multi-user (MU) MIMO.

Precoding, as used herein, may refer to a generalization of beamforming to support multi-stream transmission in multi-antenna wireless communications (e.g., MIMO). For example, single-stream beamforming in MIMO transmission from the base station 105, the same signal is emitted from each of the antennas 234 on the DL with a respective phase and gain (weighting). The weighting can be structured such that the received signal power from the base station 105 is maximized at the UE 115. When the receiver (e.g., the UE 115) has multiple antennas, single-stream beamforming cannot simultaneously maximize the signal level at all of the receive antennas 252. Thus in order to maximize throughput in multiple receive antenna systems (e.g., the UE 115), multi-stream transmission can be beneficial.

In point-to-point systems, precoding can mean that multiple data streams are emitted from the transmit antennas with independent and appropriate weightings such that the link throughput is maximized (e.g., a high SPEFF value) at the receiver (e.g., the UE 115). In MU-MIMO, the data streams can be intended for receipt at different users (for example, space division multiple access (SDMA)). In point-to-point systems, some of the benefits of precoding can be realized without requiring channel state information at the base station 105, while such information is essential to handle the inter-user interference in multi-user systems.

The plot 400 further depicts a second set of subband SPEFF calculations, depicted as multiple subband SPEFF calculations 422a-422d (collectively subband SPEFF 422). The subband SPEFF 422 is shown as a gray bar graph separated in time from the first subband SPEFF 412 with an ellipsis. Such a separation indicates the periodic nature of SPEFF calculations at the modem 325.

The modem 325 can further take an average of the individual subband SPEFF 412 to determine a wideband SPEFF 414. The wideband SPEFF 414 is shown as a regressive line over the tops of the subband SPEFF 412 and can be representative of the average SPEFF over the entire wideband signal or spectrum at a given time. In some embodiments, the wideband SPEFF 414 can vary with the UL and DL signal and is periodically recalculated.

In some embodiments, the modem 325 can use a linear average of the subband calculations 412 to determine the wideband SPEFF 414. In some embodiments, the resulting value is a single number representing the (average) wideband SPEFF 414 for that periodic SPEFF determination. The modem 325 can reference the average wideband SPEFF 414 when tuning the antennas 252. The modem 325 can conduct the same processes continuously resulting in for example, the wideband SPEFF 424.

The modem 325 can further filter the wideband SPEFF values over time as the values change. The cost function 330 can use the IIR filter 345 to determine an IIR-filtered maximum wideband SPEFF (not shown). Over the time domain, IIR filtering coefficients and time blocks can be selected such that the IIR filtered wideband SPEFF reflects the slow-varying channel statistics resulting from the user proximity to the antennas 252. For example, IIR filtering can eliminate fast-fading channel variations present in the wideband SPEFF 414, 424 allowing the cost function 330 to optimize antenna tuning based on variations based on the near-field user proximity effect, such as a user grip or head interference with one or more MIMO antennas 252.

The cost function 330 can further be based on a maximum IIR filtered wideband SPEFF (not shown). The “maximum” IIR filtered wideband SPEFF 410 can relate to an overall PMI and RI hypothesis that provide optimum tuning of the antennas 252. In an embodiment, such as for example, closed loop MIMO, the UE 115 (e.g., the modem 325) can make SPEFF determinations conditioned on an allowed set of precoding matrices and transmit the PMI to the base station 105 (e.g., an eNB in an LTE environment). In another embodiment, such as for example, open loop MIMO, no PMI is reported by the UE 115. The UE 115 can make SPEFF determinations conditioned on the assumption of rank1 and rank2, or rank2 and rank4, if supported. The UE 115 can then transmit a rank index (RI) corresponding to the maximum wideband SPEFF to the base station 105.

In some embodiments, the wideband SPEFF 414, 424 can have a maximum theoretical value. Such a maximum value can be based on Shannon's theorem. In information theory, Shannon's theorem specifies the maximum rate at which information can be transmitted over a communications channel of a specified bandwidth in the presence of noise. The theorem establishes a channel capacity for a communication link (e.g., between the base station 105 and the UE 115) or a bound on the maximum amount of error-free digital data (e.g., information) that can be transmitted with a specified bandwidth in the presence of the noise interference. Thus, the maximum value can provide bounded objectives within which the cost function 330 can operate.

For example, if the maximum IIR filtered wideband SPEFF determined by the modem 325 at the UE 115 is represented by “SPEFF_CALC” and the maximum theoretical SPEFF is represented by “SPEFF_MAX.” Thus the cost function 330 can be represented by a function L(t), calculated by the following equation:

L(t)=1−(SPEFF_CALC/SPEFF_MAX) (1)

Where L is the cost function 330 as a function of time. In some embodiments, such a value of L is bounded within a value from zero (0) to one (1). Accordingly, the L(t) explained by equation (1) is a linear function, where the objective is to minimize the value of L. The higher the wideband SPEFF 414, 424, and more particularly, the higher the maximum IIR filtered wideband SPEFF, the lower the value of L.

In another embodiment, the cost function 330 can be represented as:

L(t)=1−(SPEFF_CALC/SPEFF_MAX)² (2)

In equation 2, the cost function L (e.g., the cost function 330) as a function of time (t) varies as the square of the Shannon-based maximum SPEFF of the system 100. In some embodiments, the value of L is for equation 2 is also bounded between zero (0) to one (1). In some embodiments, the quadratic forms of the cost function 330, such as for example, equation (2), ensure convergence to a global minimum value for L.

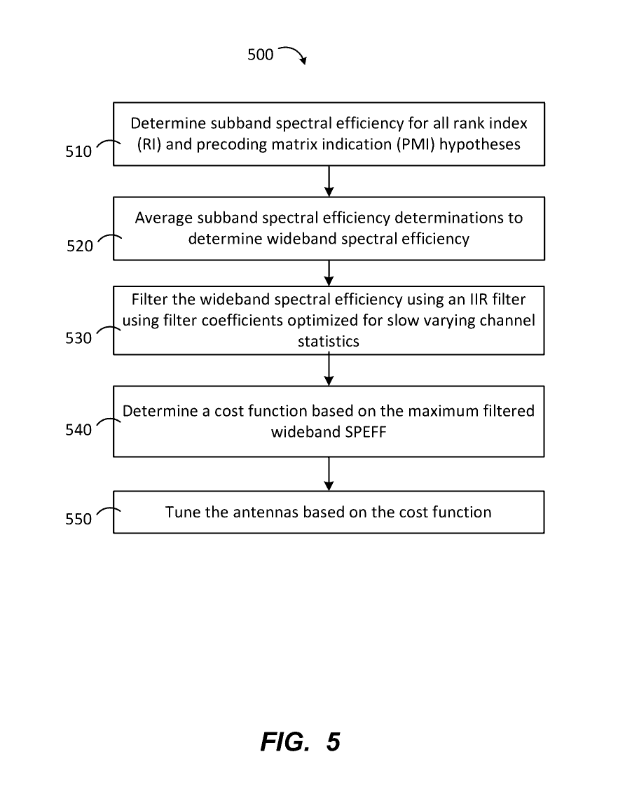

FIG. 5 is a flowchart of a method 500 for tuning MIMO antennas. In one embodiment the depicted method is carried out by the modem 325. At block 510 the modem determines a subband spectral efficiency (e.g., the subband SPEFF 412) for one or more of a series of transmissions. The subband SPEFF 412 determinations can be made at the modem 325 (FIG. 3). Each of the SPEFF 412, 422 determinations can be made periodically and continuously through the operations of the UE 115. The subband SPEFF 412, 414 can further be based on all RI and PMI hypotheses.

At block 520, the modem can average the subband SPEFF 412, 422 to determine the wideband SPEFF 414, 424. In some embodiments, the wideband SPEFF 414, 424 can be a linear average, resulting in a single number describing the spectral efficiency at that moment for a particular transmission. In some embodiments the wideband SPEFF 414, 424 can have a value from 0 to 1.

At block 530, the modem 325 can apply the IIR filter 345 to the maximum wideband SPEFF 414, 424. The modem 325 can select time blocks over which to apply selected IIR filter coefficients. Such filtering can allow the modem 325 to focus on the slow-varying channel statistics, by filtering out the fast-fading values. The maximum IIR filtered wideband SPEFF then corresponds to the most efficient antenna tuning that corresponding to mechanical antenna blockage. Accordingly, the modem 325 can most efficiently tune the antennas 252 based on head and hand proximity effects on the antennas 252 and more effectively make use of the antennas 252 and the transmission medium.

Although embodiments of the disclosure are described above for particular embodiments, many variations of the disclosure are possible. For example, the numbers of various components may be increased or decreased, modules and steps that determine a supply voltage may be modified to determine a frequency, another system parameter, or a combination of parameters. Additionally, features of the various embodiments may be combined in combinations that differ from those described above.

Those of skill will appreciate that the various illustrative blocks described in connection with the embodiments disclosed herein can be implemented in various forms. Some blocks have been described above generally in terms of their functionality. How such functionality is implemented depends upon the design constraints imposed on an overall system. Skilled persons can implement the described functionality in varying ways for each particular application, but such implementation decisions should not be interpreted as causing a departure from the scope of the disclosure. In addition, the grouping of functions within a block or step is for ease of description. Specific functions or steps can be moved from one block or distributed across to blocks without departing from the present disclosure.

The various illustrative logical blocks described in connection with the embodiments disclosed herein, for example, the modem 325, can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller (e.g., the modem 325 as disclosed herein), microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the present disclosure. Various modifications to these embodiments will be readily apparent to those skilled in the art, and the generic principles described herein can be applied to other embodiments without departing from the spirit or scope of the present disclosure. Thus, it is to be understood that the description and drawings presented herein represent a presently preferred embodiment of the present disclosure and are therefore representative of the subject matter which is broadly contemplated by the present disclosure. It is further understood that the scope of the present disclosure fully encompasses other embodiments that may become obvious to those skilled in the art and that the scope of the present disclosure is accordingly limited by nothing other than the appended claims.

What is claimed is:

1. A method for tuning multiple-in multiple-out (MIMO) antennas, comprising:
determining a plurality of subband spectral efficiency values related to the MIMO antennas;
determining a wideband spectral efficiency by averaging the plurality of subband spectral efficiency values;
filtering the wideband spectral efficiency using an infinite impulse response (IIR) filter to determine an IIR filtered wideband spectral efficiency;
determining a cost function based on a maximum value of the IIR filtered wideband spectral efficiency; and
tuning the MIMO antennas based at least in part on the cost function.

2. The method of claim 1, further comprising selecting at least one IIR filter coefficient for use with the IIR filter to reflect slow-varying channel statistics, the slow varying channel statistics relating to a mechanical blockage of one or more of the MIMO antennas.

3. The method of claim 1, wherein each subband spectral efficiency value of the plurality of subband spectral efficiency values relates to a subband, the subband being a portion of a wideband spectrum divided based on precoding matrix indications and rank index hypotheses.

4. The method of claim 1, wherein the wideband spectral efficiency is a value equal to a linear average of the plurality of subband spectral efficiency values.

5. The method of claim 1, wherein the wideband spectral efficiency is a value equal to a weighted average of the plurality of subband spectral efficiency values based on a subband, the subband being a portion of a wideband spectrum.

6. The method of claim 1, wherein the cost function is proportional to a ratio of the maximum IIR filtered wideband spectral efficiency to a theoretical maximum spectral efficiency.

7. The method of claim 1, wherein the cost function varies with the square of a ratio of the maximum IIR filtered wideband spectral efficiency to a theoretical maximum spectral efficiency, the theoretical maximum spectral efficiency being based on Shannon's theorem.

8. A device for tuning multiple-in multiple-out (MIMO) antennas, comprising:
a processor configured to:
determine a plurality of subband spectral efficiency values related to the MIMO antennas;
determine a wideband spectral efficiency by averaging the plurality of subband spectral efficiency values;
filter the wideband spectral efficiency using an infinite impulse response (IIR) filter to determine an IIR filtered wideband spectral efficiency; and
determine a cost function based on a maximum value of the IIR filtered wideband spectral efficiency; and
a plurality of tuners operably coupled to the MIMO antennas and the processor, and configured to tune the MIMO antennas based on the cost function.

9. The device of claim 8 wherein the processor is further configured to perform at least a portion of the functions of a modem.

10. The device of claim 8 wherein the processor is further configured to select at least one IIR filter coefficient for the IIR filter, the at least one IIR filter coefficient being selected to reflect slow-varying channel statistics, the slow-varying channel statistics relating to a mechanical blockage of one or more of the MIMO antennas.

11. The device of claim 8, wherein each subband spectral efficiency value of the plurality of subband spectral efficiency values relates to a subband, the subband being a portion of a wideband spectrum divided into a plurality of subbands based on precoding matrix indication and rank index hypotheses.

12. The device of claim 8, wherein the wideband spectral efficiency is a value equal to a linear average of the plurality of subband spectral efficiency values.

13. The device of claim 8, wherein the cost function is proportional to a ratio of the maximum IIR filtered wideband spectral efficiency to a theoretical maximum spectral efficiency.

14. The device of claim 8, wherein the cost function varies with the square of a ratio of the maximum IIR filtered wideband spectral efficiency to a theoretical maximum spectral efficiency, the theoretical maximum spectral efficiency being based on Shannon's theorem.

15. An apparatus for tuning antennas in a multiple-in multiple-out (MIMO) system, the MIMO system having a first antenna and a second antenna, the apparatus comprising:
a processor means for
determining a plurality of subband spectral efficiency values related to the MIMO antennas,
determining a wideband spectral efficiency by averaging the plurality of subband spectral efficiency values,
filtering the maximum wideband spectral efficiency using an infinite impulse response (IIR) filter,
determining a cost function based on the maximum IIR filtered wideband spectral efficiency; and
a means for tuning the MIMO antennas based at least in part on the cost function.

16. The apparatus of claim 15, wherein the processor means is a modem.

17. The apparatus of claim 15, wherein the processor means is further for selecting at least one IIR filter coefficient to reflect slow-varying channel statistics, the slow-varying channel statistics relating to a mechanical blockage of one or more of the MIMO antennas.

18. The apparatus of claim 15, wherein each subband spectral efficiency value of the plurality of subband spectral efficiency values relates to a subband, the subband being a portion of a wideband spectrum divided based on precoding matrix indications and rank index hypotheses.

19. The apparatus of claim 15, wherein the wideband spectral efficiency is a value equal to a linear average of the plurality of subband spectral efficiency values,

20. The apparatus of claim 15, wherein the wideband spectral efficiency is a value equal to a weighted average of the plurality of subband spectral efficiency values based on a subband, the subband being a portion of a wideband spectrum.

21. The apparatus of claim 15, wherein the cost function is proportional to a ratio of the maximum IIR filtered wideband spectral efficiency to a theoretical maximum spectral efficiency.

22. The apparatus of claim 15, wherein the cost function varies with the square of a ratio of the maximum IIR filtered wideband spectral efficiency to a theoretical maximum spectral efficiency, the theoretical maximum spectral efficiency being based on Shannon's theorem.

23. A non-transitory computer readable medium containing instructions that when performed by a processor in a multiple-in multiple-out (MIMO) system having a plurality of MIMO antennas, cause the processor to:
determine a plurality of subband spectral efficiency values related to the MIMO antennas;
determine a wideband spectral efficiency by averaging the plurality of subband spectral efficiency values;
filter the wideband spectral efficiency using an infinite impulse response (IIR) filter to determine an IIR filtered wideband spectral efficiency;
determine a cost function based on a maximum value of the IIR filtered wideband spectral efficiency; and
tune the MIMO antennas based at least in part on the cost function.

24. The non-transitory computer readable medium of claim 23, further comprising instructions that cause the processor to select at least one IIR filter coefficient for use with the IIR filter to reflect slow-varying channel statistics, the slow varying channel statistics relating to a mechanical blockage of one or more of the MIMO antennas.

25. The non-transitory computer readable medium of claim 23, wherein each subband spectral efficiency value of the plurality of subband spectral efficiency values relates to a subband, the subband being a portion of a wideband spectrum divided based on precoding matrix indications and rank index hypotheses.

26. The non-transitory computer readable medium of claim 23, wherein the wideband spectral efficiency is a value equal to a linear average of the plurality of subband spectral efficiency values,

27. The non-transitory computer readable medium of claim 23, wherein the wideband spectral efficiency is a value equal to a weighted average of the plurality of subband spectral efficiency values based on a subband, the subband being a portion of a wideband spectrum.

28. The non-transitory computer readable medium of claim 23, wherein the cost function is proportional to a ratio of the maximum IIR filtered wideband spectral efficiency to a theoretical maximum spectral efficiency.

29. The non-transitory computer readable medium of claim 23, wherein the cost function varies with the square of a ratio of the maximum IIR filtered wideband spectral efficiency to a theoretical maximum spectral efficiency, the theoretical maximum spectral efficiency being based on Shannon's theorem.
